(19) United States
(12) Patent Application Publication
(10) Pub. No.: US 2010/0043715 A1
(43) Pub. Date: Feb. 25, 2010

(54) Shield for animal food container

(75) Inventors: Lawrence R. Carter, Richland, MI (US); David D. Gleason, Kalamazoo, MI (US); Craig S. Biland, Mattawan, MI (US)

Correspondence Address: FLYNN THIEL BOUTELL & TANIS, P.C., 2026 RAMBLING ROAD, KALAMAZOO, MI, 49008-1631, US

(73) Assignee: Unifab Corporation

(21) Appl. No.: 12/583,117

(22) Filed: Aug. 14, 2009

Related U.S. Application Data
(60) Provisional application No. 61/189,808, filed on Aug. 22, 2008.

(51) Int. Cl. A01K 5/00

(52) U.S. Cl. 119/61.55

(57) ABSTRACT

A method of feeding an animal and a combination of a container configured to hold animal food material and a shroud therefor. The container includes an upright cup-shaped thin walled thermoplastic member having a bottom wall and an upstanding sidewall integrally formed with the bottom wall. An upper edge of the sidewall terminates in an annular rim structure defining the perimeter limits of an opening into an interior region of the container. The shroud includes an inverted cup-shaped member that has a top wall with a centrally oriented opening therethrough and an annular skirt depending downwardly from an outer perimeter of the top wall. The shroud is configured to fit over the opening into the interior region of the container to provide a protective shield preventing animals from gaining access to said thermoplastic material of the container while simultaneously allowing an animal to gain access to any contents in the interior region of the container.

### CROSS-REFERENCE TO RELATED APPLICATION

This application claims the benefit of U.S. Provisional Application No. 61/189,808, filed Aug. 22, 2008, the disclosure of which is incorporated herein by reference in its entirety.

### FIELD OF THE INVENTION

This invention relates to a method of feeding an animal and to an animal feeding assembly and, more particularly, to a combination of a synthetic resin animal food holding container shielded from contact by the animal but simultaneously allowing the animal access to the food in the container.

### BACKGROUND OF THE INVENTION

While this invention arose while studying and feeding of laboratory rodents, namely mice and rats, the scope of this disclosure is to apply to animals in general.

Whether for enrichment purposes or for nesting, it is well known that rodents take advantage of every opportunity to chew on and destroy any unprotected materials such as plastic, fabric, Styrofoam and the like. Therefore, feeder devices used in rodent cages are commonly made of two basic materials, namely, glass and stainless steel. These two materials allow for safe and regulated food delivery to the animal in addition to providing a sanitizable, reusable feeding device for the vivarium. However, it is necessary to sanitize the glass and stainless steel materials at the end of each and every feeding cycle and then filling the food holding containers with materials that have Active Pharmaceutical Ingredients (API). Personnel contact with meal containing API is an issue especially for drug in diet studies (commonly 5% drug to meal ratio) which can require thousands of feeders to be filled on a weekly basis. While engineering controls and Personnel Protective Equipment (PPE) can reduce personnel exposure during the manual feeder filling process, the potential for contact with the API meal or simple dust from meal with or without API always exists. Thus, it is desirous to provide an animal feeding assembly that will effectively reduce personnel exposure to API meal and/or meal dust while simultaneously eliminating the capability of the animal to gain access to the material of the meal holding container during the feeding process.

Accordingly, it is an object of this invention to provide a method of feeding an animal and an animal feeding assembly that eliminates the capability of the animal to gain access to the material of the meal holding container during the feeding process while simultaneously allowing animal access to any meal contained in the container.

### SUMMARY OF THE INVENTION

In general, the objects and purposes of the invention are met by providing a method of feeding an animal and a combination of a container configured to hold animal food material and a shroud therefor. The container includes an upright cup-shaped thin walled thermoplastic member having a bottom wall and an upstanding sidewall integrally formed with the bottom wall. An upper edge of the sidewall terminates in an annular rim structure defining the perimeter limits of an opening into an interior region of the container. The shroud includes an inverted cup-shaped member that has a top wall with a centrally oriented opening therethrough and an annular skirt depending downwardly from an outer perimeter of the top wall. The shroud is configured to fit over the opening into the interior region of the container to provide a protective shield preventing animals from gaining access to said thermoplastic material of the container while simultaneously allowing an animal to gain access to any contents in the interior region of the container.

### BRIEF DESCRIPTION OF THE DRAWINGS

Other objects and purposes of this invention will be apparent to persons acquainted with apparatus of this general type upon reading the following specification and inspecting the accompanying drawings, in which:

FIG. 1 is a top and front isometric view of a first embodiment of our shield for an animal food container;

FIG. 2 is a top view thereof;

FIG. 3 is a front view thereof;

FIG. 4 is a sectional view taken along the line 4-4 in FIG. 2;

FIG. 5 is a top and front isometric view of a second embodiment of our shield for an animal food container;

FIG. 6 is a top view thereof;

FIG. 7 is a front view thereof; and

FIG. 8 is a sectional view taken along the line 808 in FIG. 6.

### DETAILED DESCRIPTION

Certain terminology will be used in the following description for convenience in reference only and will not be limiting. The words “up”, “down”, “right” and “left” will designate directions in the drawings to which reference is made. The words “in” and “out” will refer to directions toward and away from the geometric center of the device and designated parts thereof. Such terminology will include derivatives and words of similar import.

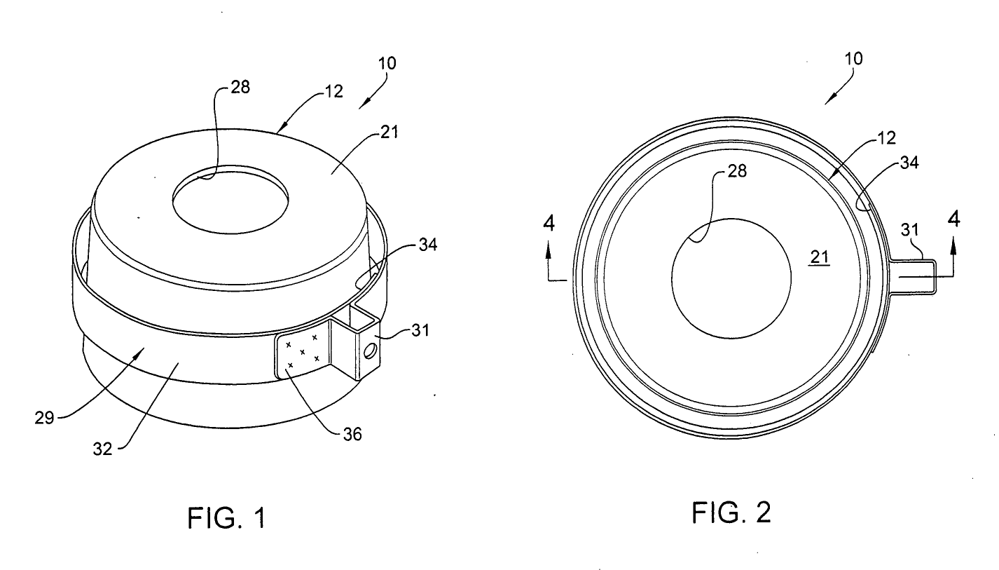

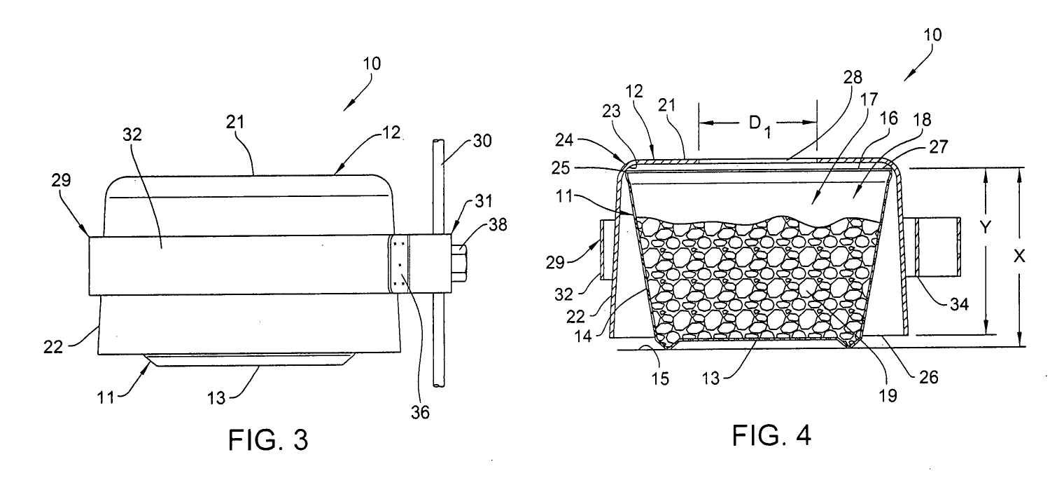

FIGS. 1 to 4 illustrate a first embodiment of a combination 10 of a meal holding cup-shaped container 11 and a shroud or shield 12 for protecting the container from animal contact with the material of the container. More specifically, and referring first to FIG. 4, the meal holding container 11 is made of a non-toxic thermoplastic material having an integrally formed bottom wall 13 and a sidewall 14 upstanding a first distance “X” from a support surface 15 and, generally, the outer perimeter of the bottom wall 13. In this embodiment, the sidewall 14 is inclined outwardly from the bottom wall 13 to facilitate multiple containers to be conveniently stacked or nested together for storage purposes. The thermoplastic bottom wall 13 and sidewall 14 have a uniformly thick thin walled construction. The upper edge of the sidewall 14 terminates in an annular rim 16 defining the perimeter limits of an opening 17 into an interior space 18 of the container 11. Animal meal 19 is housed with the interior 18 of the container 11.

If desired, the container can be made of a compostable material or a bio-degradable material.

The shroud or shield 12 is an inverted cup-shaped member made of a metal material, preferably a non-corrosive material such as stainless steel. The shield 12 includes a top wall 21 and an annular skirt 22 depending downwardly from the outer perimeter of the top wall 21. The outer diameter of the skirt 22 adjacent the top wall 21 is less than the outer diameter at the lower edge 26 to facilitate a nesting of one shroud within another shroud when oriented in a stacked array. In this particular embodiment, the underside or surface 23 of the shield 12 at the juncture 24 between the top wall 21 and the skirt 22 contacts as at 25 the annular rim 16 of the container 11 so that the shield 12 is supported by the container 11 at the rim 16. When the underside or surface 23 of the shield contacts as at 25 on the annular rim 16, the height “Y” of the skirt 22 on the shield 12 measured from a lower edge 26 thereof up to the top edge 27 of the annular rim 16 of the container 11 is less than the height “X” of the sidewall 14 of the container.

The top wall 21 of the shield 12 is generally horizontally flat and has a centrally oriented hole 28 extending therethrough. The size or diameter “D₁” of the hole 28 is of importance when the shroud or shield is used in a rodent environment, particularly a laboratory rat environment wherein the rats are in the range of about 219 to 890 grams in weight. In this environment, the diameter “D₁” of the hole 28 is in the range of 2.5 inches to 3.5 inches and is optimally about 2.5 inches. In order for the shield to work effectively with the container 11 to prevent the rat from chewing on the thermoplastic material of the container, particularly at the rim 16 thereof, we have found it beneficial to provide a stabilizer ring mechanism 29 having a fastening feature 31 thereon enabling the stabilizer ring mechanism 29 to be fastened to, for example, the cage structure 30 for the rat. During our study, it was noted that rats are curious animals and learn over time to lift the shield 12 up and away from the container 11 to gain access to the opening 17 and the animal meal 19 contained within the interior space 18 of the container 11. Furthermore, after lifting the protective shroud 12, the rats also gained access to the material of the container 11 at the rim 16 and chewed it. The inner diameter of the ring mechanism 29 is slightly greater than the largest outer diameter of the skirt 22. An anchoring of the stabilizer ring mechanism 29 to a stationary object, such as the cage structure 30 for the rat, prevented the rat from moving the shroud or shield 12 relative to the container 11.

In this particular embodiment, the stabilizer ring mechanism 29 comprises a flat band 32 of metal, here stainless steel, of finite length encircling the skirt 22. The face of the band 32 opposing the outwardly facing face of the skirt 22 is not secured to the skirt 22. Terminal ends 34 and 36 of the band overlap and are secured to one another by any convenient means. The fastening feature 31 is mounted to the terminal end 36. A screw 38 and the like can be used in a conventional way to facilitate the securement of the fastening feature 31 to the cage structure 30.

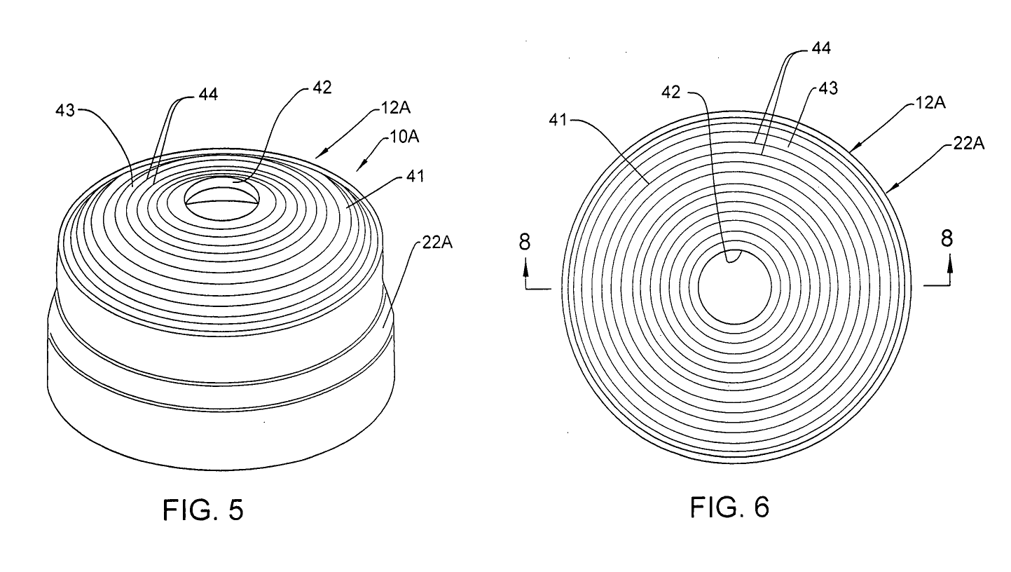

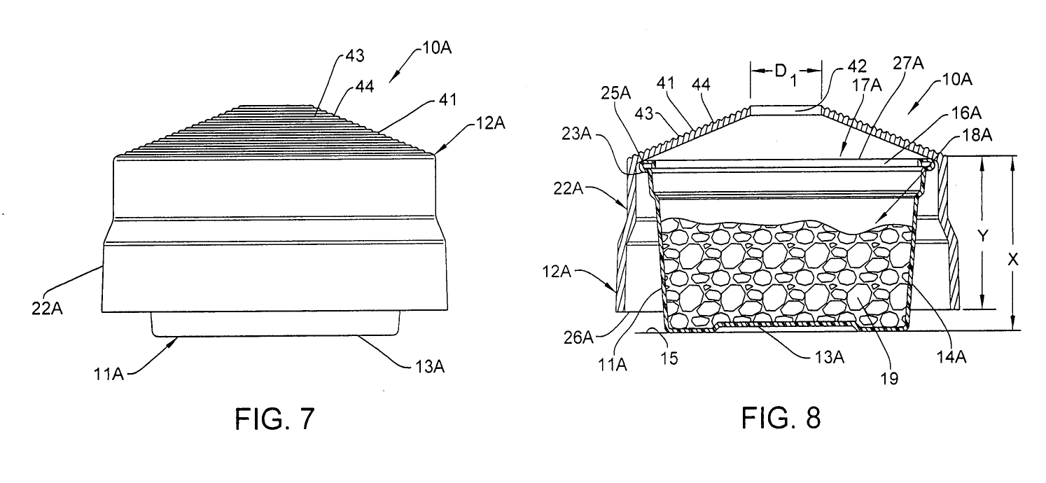

FIGS. 5 to 8 illustrate a second embodiment of a combination 10A of a shroud or shield configuration 12A for a thermoplastic cup-shaped container 11A configured for holding meal material for an animal. This embodiment is particularly configured for use with laboratory mice having a weight that is in the range of 13-42 grams. The container 11A is configured smaller than the container illustrated in FIG. 4, even though the container in FIG. 8 is shown to be approximately the same size as is shown in FIG. 4. Nevertheless, the container 11A has a bottom wall 13A and an upstanding sidewall 14A terminating in an annular rim structure 16A which defines the perimeter limits of an opening 17A into an interior space 18A of the container 11A. Animal meal 19 is housed within the interior region 18A of the container 11A. In this particular configuration for the container 11A, the annular rim structure 16A is of a curled and sturdier construction so as to be able to support the weight of the shield 12A.

The shield 12A is an inverted cup-shaped member made of metal, here stainless steel. The shield 12A includes a conical-shaped top wall 41 having a through opening 42 oriented at the apex of the cone. The opening 42 has a diameter D₂ that is in the range of 0.75 inches to 2 inches, the 0.75 inch diameter being preferable. The upper surface 43 of the top wall 41 is scored as at 44 so as to provide structure for a mouse to grab onto. An annular skirt 22A depends from the outer periphery of the conical-shaped top wall 41. The outer diameter of the skirt 22A adjacent the top wall 41 is less than the outer diameter of the skirt at the lower edge 26A to facilitate a nesting of one shroud within another shroud when oriented in a stacked array. An underside or surface 23A of the shroud 12A contacts as at 25A the annular rim 16A so that the container 11A supports the entire weight of the shroud 12A just as occurs in the previously described embodiment. Height “X” of the sidewall 14A of the container 11A measured from a support surface 15 to the upper edge 27A of the annular rim structure 16A is greater that the height “Y” of the depending annual skirt 22A measured from the location 23A of engagement with the annular rim 16A to the lower annular edge 26A thereof. As a result, all of the weight of the shroud or shield 12A is supported on the annular rim 16A of the container 11A.

In use, the interior regions of containers 11 or 11A are filled by hand or by a conventional automated meal filling machine to an appropriate level with animal meal with or without API and are generally closed and sealed shut by a removable thin material foil cover adhesively secured to the upper surface of the annular rim 16, 16A. This will enable personnel to carry the meal containing containers 11 or 11A to and around the laboratory without the risk of spillage of the API meal contents. Laboratory personnel, donning PPE equipment, can carefully remove the sealed foil closure by pealing it away from the rim structure of a selected container and thereafter place the container into the proper position within an animal cage. In some instances, the cover will not be required so that the container can be placed into the cage after it has been filled. Thereafter, the appropriate shroud 12 or 12A is oriented over the now open container so that the skirt portion thereof covers up a major portion of the sidewall 14, 14A of the container. The through opening 28, 42 will allow the animal in the cage to access the meal content, with or without API, while the remainder portion of the top wall 21, 41 and the skirt portion 22, 22A will simultaneously prevent the animal access to the thermoplastic material of the container to thereby prevent the animal from chewing on the thermoplastic material of the container. In some instances, it will be beneficial to secure a stabilizer ring 29 encircling the shroud 12, especially in the environment of large rats, to a stationary object, such as the cage structure 30, in order to prevent the animal from lifting the shroud up and off from the container 11.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A combination of a container configured to hold animal food material and a shroud therefor, comprising:
an upright cup-shaped thin walled thermoplastic container having a bottom wall and an upstanding sidewall integrally formed with said bottom wall, an upper edge of said sidewall terminating in an annular rim structure defining the perimeter limits of an opening into an interior region of the container; and
an inverted cup-shaped shroud having a top wall with an opening therethrough and an annular skirt depending downwardly from an outer perimeter of said top wall, said shroud being configured to fit over the open top of said container to provide a protective shield preventing animals from gaining access to said thermoplastic material of said container, said opening in said top wall being configured to allow an animal to gain access to any contents in said interior region of said container.

2. The combination according to claim 1, wherein said through opening in said top wall of said cup-shaped shroud is centrally oriented on said top wall.

3. The combination according to claim 1, wherein said cup-shaped shroud includes a stabilizing mechanism for minimizing relative movement between said container and said shroud initiated by the animal.

4. The combination according to claim 3, wherein said stabilizing mechanism is an annular ring configured to encircle said skirt on said shroud, said stabilizing mechanism also including a connection mechanism for facilitating a securement of said annular ring to a stationary object.

5. The combination according to claim 4, wherein said container and said shroud therefor are oriented inside an animal cage, and wherein said stationary object is said animal cage.

6. The combination according to claim 1, wherein said top wall of said shroud is in a form of an inverted cone with said through opening being located at an apex of the cone, and wherein an upwardly facing surface of said top wall is scored for the purpose of providing additional surface area that the animal can grip.

7. The combination according to claim 1, wherein said container is made of a chewable thermoplastic material, wherein said shroud is configured to be entirely supported on said annular rim of said container so that the animal will be prevented from gaining access to the material of said container at said rim to thereby prevent the animal from chewing on said material at said rim.

8. The combination according to claim 1, wherein said annular skirt has a first diameter adjacent said top wall that is less than a second diameter adjacent a lower edge thereof in order to facilitate a nesting of one shroud within another shroud when oriented in a stacked array.

9. A method of providing animal meal to an animal, comprising the steps of:
providing an open top, cup-shaped container filled to an appropriate level with animal meal;
placing said meal containing container in a confined area whereat an animal is located;
orienting an inverted cup-shaped shroud having a top wall with a through opening therein and a skirt extending away from an outer perimeter portion of the top wall over said container so that the top wall of the shroud covers the open top portion of the container and the skirt portion of the shroud covers a sidewall of the container in a way that prevents the animal from gaining access to the material of the container while simultaneously allowing animal access to the animal meal through the opening through the top wall of the shroud.

10. The method according to claim 9, wherein the orienting step includes the further step of orienting a stabilizing mechanism relative to the shroud so that an animal initiated relative movement between the container and the shroud is minimized.

11. The method according to claim 10, wherein the further step includes an additional step of securing the stabilizing mechanism to a stationary object.

12. The method according to claim 11, wherein the stabilizing mechanism is an annular ring, and wherein the providing step includes the step of orienting the container inside the annular ring and an orienting of the shroud over the top of the container and so that it is entirely supported by the top edge of the container with the shroud being oriented inside the annular ring.

13. The method according to claim 11, wherein the additional step involves a securing of the stabilizing mechanism to a stationary part of an animal cage.

14. The method according to claim 9, wherein the open top of the container is sealed closed by a removable cover, and wherein the placing step includes the further step of removing the removable cover to expose the animal meal through the open top.
